(19) United States
(12) Patent Application Publication
(10) Pub. No.: US 2007/0065662 A1
(43) Pub. Date: Mar. 22, 2007

(54) Infrared activated thermoplastic bonding substrate

(75) Inventors: Dale Bennett, Benton, LA (US); Robert Flaherty, Ruston, LA (US)

Correspondence Address: RAYMOND R. MOSER JR., ESQ.;MOSER IP LAW GROUP, 1040 BROAD STREET, 2ND FLOOR, SHREWSBURY, NJ, 07702, US

(73) Assignee: Ludlow Coated Products, Shreveport, LA (US)

(21) Appl. No.: 11/228,174

(22) Filed: Sep. 16, 2005

(51) Int. Cl. B32B 7/12

(52) U.S. Cl. 428/354; 428/343

(57) ABSTRACT

A laminated substrate and method of making same using an infrared activated thermoplastic adhesive material coated on one side of a linerboard substrate and a plastic material extruded to the other side of the linerboard substrate. The thermoplastic material having a mineral additive to act as a heat sink when the substrate is exposed to infrared radiation.

### TECHNICAL FIELD

The present invention relates to thermal bonding of substrates and more particularly to a process and apparatus for laminating a polymeric film to a substrate and activation of a mineral filled thermoplastic adhesive.

### BACKGROUND

Coated embossed polymeric film materials are used in a wide variety of applications. For example, paper based products may be coated with a polymeric film and used to simulate leather panels, photographic paper, door panels, etc. These types of products are produced by extrusion coating a polymeric film onto a paper substrate and embossing a pattern onto the exposed surface of the film. Polymeric films may also be exposed to heat to activate adhesive properties thereby being used as a bonding agent. In a conductive type lamination process, the film and paper substrate are run over heated rollers. The heat employed in this lamination process is sufficient to melt the thermoplastic material (usually in the range of approximately 110° C.-120° C.) and drives the heat through the paper substrate. A drawback with using heated rollers in this manner is that the heated roller comes in contact with the film and destroys any embossed pattern on the film. In addition, the rollers must be hotter than the melting point of the thermoplastic material in order for the melting point of the material to be reached. These very hot rollers inadvertently heat the opposite surface of laminate. This creates a temperature gradient through the material which is cooler as you approach the outer surface. This temperature gradient causes bubbling because the inherent moisture content of the paper substrate escapes. This results in blistering and bubbling of the paper substrate leading to composition breakdown.

### BRIEF DESCRIPTION OF THE DRAWINGS

Features and advantages of the present invention are set forth herein by description of embodiments consistent with the present invention, which description should be considered in conjunction with the accompanying drawings, wherein:

FIG. 1 is a schematic diagram illustrating the various layers of the laminated substrate consistent with the present invention;

FIG. 2 illustrates a schematic diagram illustrating the various layers of the laminated substrate and the heating operation.

### DETAILED DESCRIPTION

The present application relates to a laminated substrate using an infrared activated thermoplastic adhesive and process for making the same. In one embodiment, a surface of a linerboard substrate is coated with a thermoplastic resin. The coating is activated by infrared emitters and the substrate may be bonded to various materials, for example polystyrene foams, wood based products, paper products, wovens, non-wovens, cloth, etc., without compromising the integrity of the linerboard substrate such as blistering and/or bubbling.

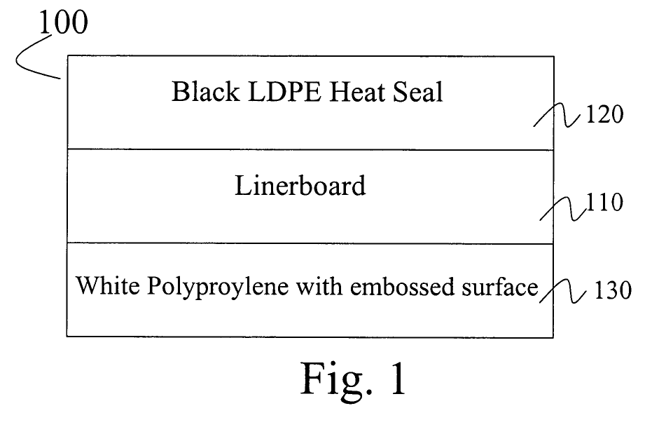

FIG. 1 illustrates an exemplary embodiment of composition 100 consistent with the present invention. Composition 100 includes a linerboard substrate 110, a first layer of thermoplastic material 120 and a plastic based material 130. Composition 100 may be for example, a cardboard based linerboard having approximately a 7 mil caliper with a moisture content of 3%-7% by weight. Thermoplastic material 120 may be various types of polymers including polyethylene copolymers such as LDPE, HDPE, LLDPE, metallocene polyethylene, EVA, EMA, EEA, EAA, EnBA, PP. In addition, thermoplastic urethanes (TPU), extrudable polyesters and extrudable nylons can act as adhesives. By way of example, thermoplastic material 120 may be a black low density polyethylene (LDPE) configured to activate as an adhesive when heated to temperatures of 110° C.-120° C.

Plastic based material 130 may be, for example, polypropylene configured to prevent the escape of moisture thereby acting as a moisture barrier and maintained typically at room temperature of approximately 30° C. However, plastic based material 130 may be an extrudable plastic configured to act as a moisture barrier. Propylene is preferable because it has a higher melting point than LDPE layer 120 on the opposite side. The differential between the layers 130 and 120 assists, but is not essential to, the temperature gradient as explained in more detail below. Various types of polymers may also be used as material 130, as well as extruded polyesters, nylons and various types of polyurethanes.

Layer 130, for example polypropylene, is extruded to linerboard substrate 110 and embossed with a desired pattern. Unfortunately, a typical cardboard based linerboard has an inherent level of moisture content which will boil and outgas around 100° C. (H2O). In order to activate the thermoplastic adhesive 120 the temperature must reach at least 110° C. In this heating process, heat transfers to the cardboard linerboard and may cause bubbling and blistering of the linerboard 110 thereby compromising the integrity of the material. Linerboard 110 may be perforated or coated to further prevent blistering and bubbling from the escape of inherent moisture.

The black LDPE layer 120 is configured to absorb infrared radiation sufficient to reduce the temperature gradient through substrate 100 while allowing the thermoplastic resin to melt to activate its adhesive properties. Layer 120 acts as a heat sink by the use of mineral additives in the amounts of 3%-5% total loading in the LDPE. Examples of such mineral additives include calcium carbonate, talc, fumed silica, mica, clay, DE, and other materials configured to provide the necessary heat sink properties to layer 120. While the amount of mineral additive, such as calcium carbonate, included with black LDPE layer 120 must be sufficient to absorb the heat to melt the thermoplastic at a rate sufficient for adhesion, it must be low enough to also prevent rapid heating of layer 120 such that if layer 120 absorbs heat too quickly, undesirable heat will be transferred to layer 110 thereby causing blistering and bubbling.

Once layer 120 is heated to 110° C.-120° C. to initiate the adhesive properties, substrate 100 may be adhered to various materials. For example, substrate 100 may be used as a substrate for a polystyrene foam material used for door face surfaces or a wood based OSB product. This adhesion may be performed through the use of nipped rollers with sufficient pressure for 2-3 second duration. Obviously, pressure and duration values may be modified to provide sufficient adhesion depending on the type of material being used.

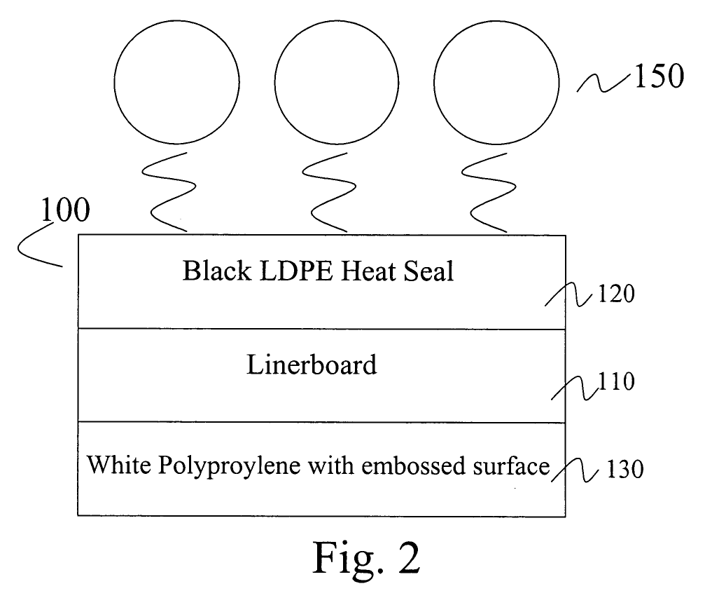

FIG. 2 illustrates an embodiment of the present invention where substrate 100 is subject to infrared (IR) emitters 150 to sufficiently heat LDPE layer 120 to activate its adhesive properties. IR emitters, for example emitters 150, supply radiant energy at a particular wavelength. By heating layer 120, substrate 100 does not come in physical contact with a conventional heating element, such as rollers. In this manner, substrate 100 does not come in contact with heating rollers thereby avoiding deterioration of embossed surface layer 130 as well as avoiding penetration of excessive heat toward linerboard substrate 110. LDPE layer 120 includes calcium carbonate to a level that acts essentially as a heat sink, thereby protecting moisture loss from linerboard layer 110. Although, layer 110 may absorb some IR energy, the levels are such that the temperature does not produce sufficient moisture loss to induce bubbling and blistering. Substrate 100 may be processed through a machine manufacturing process oriented to allow for sufficient time for LDPE layer 120 to absorb IR energy. The other side of linerboard layer 110 is coated with polypropylene acting as a moisture barrier so that moisture from linerboard 110 remains within substrate 100 as well as providing a decorative or ornamental surface opposite LDPE layer 120.

The foregoing description is provided to illustrate and explain the present invention. However, the description hereinabove should not be considered to limit the scope of the invention set forth in the claims appended here to.

What is claimed is:

1. A thermoplastic bonded substrate comprising:
a linerboard substrate;
a plastic based material extruded to a first side of said linerboard substrate; and
a thermoplastic material layer coated on a second side of said linerboard substrate, said thermoplastic layer configured to provide adhesive properties when exposed to infrared radiation, said thermoplastic material layer comprising a mineral additive in an amount sufficient to absorb heat upon activation of said adhesive properties.

2. The substrate in accordance with claim 1 wherein said thermoplastic material layer further comprises said mineral additive in an amount low enough to prevent rapid heating of said thermoplastic layer.

3. The substrate in accordance with claim 2, wherein said mineral additive is selected from the group consisting of calcium carbonate, talc, fumed silica, mica, clay and Diatomaceous Earth (DE).

4. The substrate in accordance with claim 2 wherein said substrate, when exposed to said infrared radiation, comprises a temperature gradient there-through such that said temperature gradient decreases from said thermoplastic material layer to said linerboard.

5. The substrate in accordance with claim 1 wherein said thermoplastic material is selected from the group consisting of LDPE, HDPE, LLDPE, metallocene polyethylene, EVA, EMA, EEA, EAA, EnBA and polypropylene.

6. The substrate in accordance with claim 1 wherein said thermoplastic material is selected from the group consisting of thermoplastic urethanes, extrudable polyester and extrudable nylon.

7. The substrate in accordance with claim 1, wherein said thermoplastic material is a black low density polyethylene.

8. The substrate in accordance with claim 1 wherein said plastic based material is polypropylene.

9. The substrate in accordance with claim 1, wherein said plastic based material acts as a moisture barrier to prevent the escape of moisture from said substrate.

10. A method of laminating a substrate comprising:
coating a linerboard with a thermoplastic resin, said resin having a mineral additive to act as a heat sink when exposed to infrared radiation;
extruding a plastic based material to said linerboard; and
exposing said thermoplastic resin to infrared radiation sufficient to activate adhesive properties of said resin.

11. The method in accordance with claim 10. wherein said mineral additive is selected from the group consisting of calcium carbonate, talc, fumed silica, mica, clay and Diatomaceous Earth (DE).

12. The method in accordance with claim 10 wherein said thermoplastic resin is selected from the group consisting of LDPE, HDPE, LLDPE, metallocene polyethylene, EVA, EMA, EEA, EAA, EnBA and polypropylene.

13. The method in accordance with claim 10 wherein said thermoplastic resin is selected from the group consisting of thermoplastic urethanes, extrudable polyester and extrudable nylon.

14. The method in accordance with claim 10 further comprising the step of heating said thermoplastic resin to 110° C.-120° C.

15. The method in accordance with claim 14 further comprising the step of adhering said substrate to a polystyrene foam material.
